(19) United States
(12) Patent Application Publication
(10) Pub. No.: US 2023/0058081 A1
(43) Pub. Date: Feb. 23, 2023

(54) SYSTEM AND METHODS FOR DEPTH GENERATION USING STRUCTURED LIGHT PATTERNS

(71) Applicant: Texas Instruments Incorporated, Dallas, TX (US)

(72) Inventors: Shashank Dabral, Allen, TX (US); Jaime De La Cruz, Carrollton, TX (US); Jeffrey Kempf, Dallas, TX (US)

(21) Appl. No.: 17/719,008

(22) Filed: Apr. 12, 2022

Related U.S. Application Data
(60) Provisional application No. 63/234,063, filed on Aug. 17, 2021.

(51) Int. Cl. G01S 17/89; G01B 11/25; G06T 7/55

(52) U.S. Cl. CPC G01S 17/89; G01B 11/2504; G01B 11/254; G06T 7/55; G06T 2207/10028

(57) ABSTRACT

An example apparatus includes: a controller configured to: generate a symbol pattern as a result of placing symbols based on epipolar lines; instruct an SLM to project the symbol pattern; obtain an image of a reflection of the symbol pattern; determine a first location of a symbol in the image; determine a second location of the symbol in the image; and determine a depth of the symbol as based on the first location, the second location, and an essential matrix.

### CROSS-REFERENCE TO RELATED APPLICATION

This patent application claims the benefit of and priority to U.S. Provisional Patent Application No. 63/234,063 filed Aug. 17, 2021, which application is hereby incorporated herein by reference in its entirety.

### TECHNICAL FIELD

This description relates generally to depth detection, and more particularly to methods for depth generation using structured light patterns.

### BACKGROUND

Vehicle headlights are becoming increasingly complex as new electronic systems, such as spatial light modulators (SLMs), are being implemented. SLMs are commonly used to accurately modify and project light, which has led SLM technologies to become a popular method of light projection. SLMs may be optically and/or electrically coupled to sensors to enable additional features within a vehicle headlight.

### SUMMARY

For methods for depth generation using structured light patterns, an example apparatus includes a controller configured to: generate a symbol pattern as a result of placing symbols based on epipolar lines; instruct an SLM to project the symbol pattern; obtain an image of a reflection of the symbol pattern; determine a first location of a symbol in the image; determine a second location of the symbol in the image; and determine a depth of the symbol as based on the first location, the second location, and an essential matrix.

### BRIEF DESCRIPTION OF THE DRAWINGS

FIG. 1 is a block diagram of an example automotive environment including an example vehicle, a headlight, and a depth detection headlight further including an example SLM and an example camera configured to determine the depth of symbols being projected by the SLM.

FIG. 2 is an isometric view of the block diagram of the automotive environment of FIG. 1 including illustrative representatives of an example image plane, epipole, and epipolar line.

FIG. 3 is an illustration of an example sampled grid generated as a result of a search performed on an example pattern by the depth detection headlight of FIG. 1.

FIG. 4 is an illustration of example epipolar lines based on the grid generated by the search illustrated in FIG. 3.

FIG. 5 is an illustration of example of an example pattern of symbols to be projected by the SLM of FIG. 1 and to be captured by the camera of FIG. 1.

FIG. 6 is an illustration of the pattern of FIG. 5 projected onto an example surface including an example object.

FIG. 7 is a flowchart representative of an example process that may be performed using machine readable instructions that can be executed and/or hardware configured to implement the depth detection headlight of FIG. 1, and/or, more generally, the SLM and camera of FIG. 1 to determine the depth of the symbols included in the pattern of FIGS. 5 and 6.

FIG. 8 is a flowchart representative of an example process that may be performed using machine readable instructions that can be executed and/or hardware configured to implement the depth detection headlight of FIG. 1, and/or, more generally, the SLM, controller, and camera of FIGS. 1 and 2 to determine the depth of the symbols included in the pattern of FIGS. 5 and 6 using an essential matrix.

The same reference numbers or other reference designators are used in the drawings to designate the same or similar (functionally and/or structurally) features.

### DETAILED DESCRIPTION

The drawings are not necessarily to scale. Generally, the same reference numbers in the drawing(s) and this description refer to the same or like parts. Although the drawings show layers and regions with clean lines and boundaries, some or all of these lines and/or boundaries may be idealized. In reality, the boundaries and/or lines may be unobservable, blended and/or irregular.

Automotive vehicles (e.g., cars, all-terrain vehicles (ATVs), industrial motor vehicles, sedans, sport utility vehicles (SUVs), trucks, vans, etc.), such as internal combustion engine vehicles, hybrid-electric vehicles (HEVs), electric vehicles (EVs), etc., may benefit from depth detection headlights to determine a distance between the headlight and an arbitrary object. For example, a depth detection headlight may determine the distance between the vehicle and a pedestrian. Additionally, depth detection headlights may be useful in determining features of an object, such that operations (e.g., autonomous driving) may be performed to prevent collisions, navigate difficult terrain, detect reference objects, etc.

An example depth detection headlight may include a spatial light modulator (SLM) (e.g., a digital micromirror device, a liquid crystal on silicon (LcOS), a liquid crystal display (LCD), microLED, etc.) and a camera, such that the camera may capture images projected by the SLM onto objects. In some applications, an SLM and camera may be used to determine a distance between the SLM and an object by capturing images of a series of projected patterns, where such patterns are unique with respect to each other. The depths of unique features of the object are determined based on features exhibited by the projected patterns on the object. In such applications, both the SLM and camera continue to detect the same surfaces across the series of frames in which patterns are projected to accurately determine the features of the object.

Automotive applications implementing optical depth generation (e.g., the depth detection headlight), involve depth generation being performed within a relevant timeframe for a vehicle in motion. Depth generation may be referred to as depth detection or distance detection. Optical depth detection may be performed using a single frame with a large number of unique symbols. The large number of unique symbols for single frame optical depth detection uses a high-quality optical output in order to generate the unique symbols being projected.

Examples described herein include systems and methods for optical depth detection using a single pattern of structured light projected by an SLM and an image of the pattern captured by a camera. In some described examples, a vehicle headlight includes an SLM and a camera to determine the depth of different points as a result of the SLM projecting a single pattern. The pattern used for the method of optical depth detection includes a limited number of unique symbols that are generated in a grid pattern as a result of combining a plurality of symbols to create unique sequences of symbols to determine a specific instance of a symbol. A particular occurrence of a symbol may be located as a result of searching for a sequence of symbols associated with the symbol. For example, in the sequence “ABCDBF,” a second occurrence of the letter “B” may be found by searching the sequence for the sequence of symbols “DBF,” such that the first occurrence of the letter “B” may be found by searching the sequence for the sequence “ABC.” In such an example, a specific occurrence of the letter “B” may be found as a result of searching for a sequence of symbols associated with the specific occurrence. Advantageously, using a sequence of symbols to differentiate occurrences of a symbol decreases the resolution required by an SLM to perform optical depth detection.

A depth of a particular portion of the pattern, corresponding to an object that the particular symbol is projected on, may be determined using an image of a reflection of the pattern captured by a camera with a known orientation with respect to the SLM. The location of a particular occurrence of a symbol in an image is determined by searching for a sequence of symbols surrounding the particular occurrence of the symbol, such that the symbol may be found by searching for a combination of symbols surrounding the symbol. The symbol may appear one or more times in the pattern as a result of a different sequence of symbols being used to correspond to each individual occurrence of the symbol, such that a limited number of unique symbols may be used to generate the pattern. The location of the particular symbol in the image on a corresponding epipolar line determines a distance between the SLM and the object the particular symbol is being projected on. An epipolar line is a linear line that represents the potential locations of the particular symbol across a range of depths, such that determining the location of the particular point on its corresponding epipolar line determines the depth of the area that the particular symbol is projected onto.

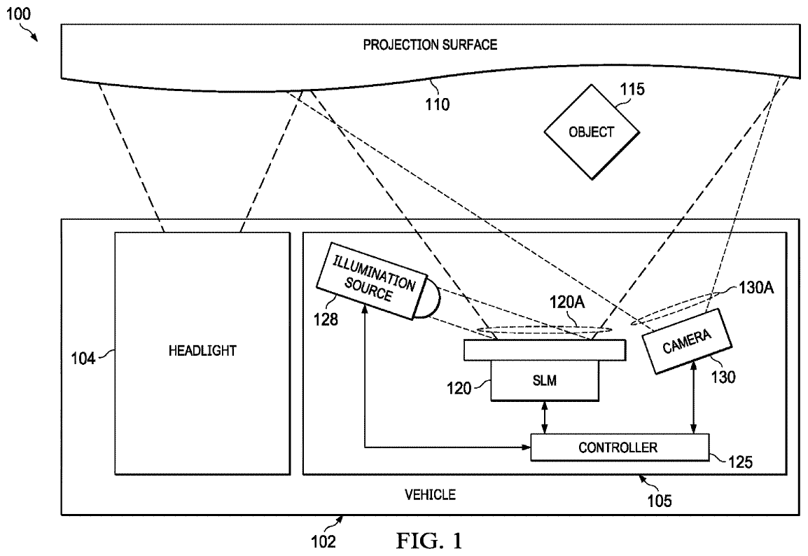

FIG. 1 is a block diagram of an example automotive environment 100 including an example vehicle 102, an example headlight 104, and a depth detection headlight 105. In the example of FIG. 1, the automotive environment 100 includes the vehicle 102, the headlight 104, the depth detection headlight 105, an example projection surface 110, and an object 115. The headlight 104 may be a depth detection headlight, similar to the depth detection headlight 105. The depth detection headlight 105 determines a distance between the depth detection headlight 105 and the object 115 as a result of determining a location of one or more symbols. For example, the depth detection headlight 105 may project an example pattern onto the projection surface 110 and the object 115 to determine the distance between the depth detection headlight 105 and the projection surface 110 and/or the object 115. Advantageously, the depth detection headlight 105 may determine distances between objects on surfaces that are not continuous, such that objects in front of the depth detection headlight 105 may be determined. The automotive environment 100 may include a plurality of depth detection headlights 105, such that the automotive environment 100 may represent the vehicle 102 including the headlights 104 and 105 as depth detection headlights.

The vehicle 102 is an automobile. For example, the vehicle 102 may be an internal combustion engine (ICE) vehicle, a hybrid electric vehicle (HEV), an electric vehicle (EV), etc. The vehicle 102 includes the headlight 104 and the depth detection headlight 105. The headlights 104 and 105 are adaptive headlights, which may adjust their operation based on conditions of the automotive environment 100. For example, the condition may be a time condition (e.g., a timestamp, a time of day, etc.), an environmental condition (e.g., a high ambient light which constitutes a daytime condition, a low ambient light constitutes a nighttime condition, etc.) a presence of an obstacle, a position of a steering wheel of the vehicle 102, an activation of a turn signal of the vehicle 102 (e.g., a status of a turn signal indicates an active turn signal condition), an input from an operator of the vehicle 102, etc., and/or a combination of thereof.

The headlights 104 and 105 include circuitry to produce, modify, and/or reflect light based on the conditions of the automotive environment 100. For example, the headlights may produce light to illuminate portions of the automotive environment 100 directly in front of the vehicle 102 as a result of determining ambient light conditions which correspond to nighttime conditions. The headlights 104 and 105 may modify and/or reflect light prior to illuminating the automotive environment to meet requirements of a mode of operation (e.g., high beam mode, low beam mode, etc.). For example, the headlights 104 and 105 may use reflectors (not illustrated for simplicity) to increase the portion of the automotive environment being illuminated, as a result of an indication from a user to enable high beam operation. The headlights 104 and 105 may include additional circuitry (e.g., sensors, cameras, lasers, etc.) to enable additional features. For example, the depth detection headlight 105 includes circuitry to enable depth detection for autonomous vehicle and obstacle detection operations. The depth detection headlight 105 may perform the operations of depth detection during durations in time wherein the headlights 104 and 105 are powered and capable of projecting a pattern for a single capture. The duration wherein the headlight performs depth detection may be a frame of operation wherein the headlight 105 projects a pattern onto the automotive environment 100.

The projection surface 110 represents the surface(s) of the automotive environment 100 that may be illuminated by the light being produced by the headlights 104 and 105. For example, the projection surface 110 may be a combination of portions of a road, that the vehicle 102 is driving on, and/or objects surrounding the road (e.g., trees, signs, other vehicles, etc.). The projection surface 110 may be any portion of the automotive environment 100 which may be illuminated by either of the headlights 104 and 105.

In the example of FIG. 1, the depth detection headlight 105 includes an example SLM 120, an example controller 125, an example illumination source 128, and an example camera 130. The depth detection headlight 105 may determine the distance between the SLM 120 and an object or surface as a result of the SLM 120 projecting a pattern, and a reflection of that pattern being captured by the camera 130, such that images captured by the camera 130 include a reflection of the pattern. For example, the SLM 120 may project a pattern of unique symbol sequences onto the projection surface 110 and the object 115 to determine a depth of different points across the projection surface 110 and object 115. In such an example, the camera 130 may capture an image of a reflection of the pattern projected onto the projection surface 110 and the object 115 to determine a depth of a location of a symbol, such that the depth of an area of which the symbol is projected onto may be determined. Advantageously, the distance between the SLM 120 and a surface that a symbol is being projected onto may be determined using the SLM 120, the camera 130, and the controller 125.

The SLM 120 is optically coupled to the projection surface 110, the object 115, and the illumination source 128. The SLM 120 is electrically coupled to the controller 125. The SLM 120 may project an image onto the projection surface 110 and object 115 based on electrical signals from the controller 125 and light being supplied by the illumination source 128 to illuminate the SLM 120. The image may comprise of a pattern of symbols, which may be used by the controller 125 to determine a depth of the surfaces being projected onto. The SLM 120 may project onto any surface located within a field of view (FoV) 120A. For example, the depth detection headlight 105 may project a pattern onto a road, which may contain the object 115 (e.g., debris, portions of a nearby vehicle, etc.), to determine whether any safety precaution should be taken to prevent a collision. In such an example, the SLM 120 would modulate light supplied by the illumination source 128 to project a pattern, determined by the controller 125, such that the camera 130 may capture an image of the reflection of the pattern. Advantageously, the SLM 120 may project a single pattern to enable the depth detection headlight 105 to determine the distance between the SLM 120 and objects (e.g., the object 115).

The controller 125 is electrically coupled to the SLM 120, the illumination source 128, and the camera 130. The controller 125 generates a pattern of symbols based on a combination of symbols which generate unique sequences. For example, the controller 125 may generate a pattern using one or more an alpha numeric letters (e.g., A, B, C, etc.), such that the symbols generate a grid of symbols that may be determined by an image of the projection. In some such examples, the controller 125 may reduce the number of unique symbols included in the pattern by generating the pattern based on unique sequences of the reduced number of symbols, such that a first occurrence of a symbol may be determined to be different than a second occurrence of the symbol as a result of determining a sequence of symbols surrounding the first occurrence corresponds to the first occurrence. The controller 125 may configure the SLM 120 to project the pattern as a result of the controller 125 instructing the SLM 120 to modulate light, supplied by the illumination source 128 to project the pattern. Advantageously, the controller 125 may generate a pattern including a number of symbols fewer than a number of points wherein symbols may be determined to be located as a result of generating the pattern using a combination of unique sequences of symbols, such that a symbol that may not be found may have an approximate location based on the corresponding sequence. Alternatively, the controller 125 may generate a pattern using a unique symbol for each point of the pattern.

The illumination source 128 is configured to supply light to the SLM 120. The illumination source 128 may include circuitry to enable the controller 125 to modify the light being supplied to the SLM 120. For example, the controller 125 may change the color temperature of the light being supplied by the illumination source 128 as a result of receiving a pulse width modulation (PWM) signal of a duty cycle corresponding to the target color temperature. The illumination source 128 may include a plurality of light emitting diodes (LEDs) to produce light of a plurality of colors. For example, the illumination source 128 may include a red LED, a green LED, and a blue LED to enable the SLM 120 to reflect light which may be perceived as a combination of each of the LEDs. In such an example, the SLM 120 may reflect purple light as a result of reflecting light from the red and blue LEDs. Alternatively, the illumination source 128 may be included in the SLM 120 circuitry.

The camera 130 is configured to capture images of reflections of the light projected onto objects (such as roads, pedestrians, obstructions, etc.) by the SLM 120. The camera 130 is electrically coupled to the controller 125. The camera 130 captures images of a field of view 130A. The field of view 130A of the camera 130 is configured to include the field of view 120A of the SLM 120, such that images capture reflections of the light being projected by the SLM 120. The camera 130 captures an image of a reflection of a pattern projected by the SLM 120, such that the controller 125 may determine the depth of each symbol location. For example, the camera 130 may capture a reflection of an image of a pattern projected by the SLM 120, determined by the controller 125, as a result of the controller 125 indicating the projection of the pattern for depth detection. In such an example, an orientation of the camera 130 may be used by the controller 125 to determine an epipolar line which may determine the depth of a symbol captured in the image of the reflection of the pattern. Advantageously, the camera 130 captures an image of a reflection of the pattern projected by the SLM 120, such that a depth may be determined for one or more symbols.

In example operation, controller 125 initiates the process of depth detection by determining a pattern of a symbols combined to form unique sequences of symbols. The SLM 120 projects the pattern of symbols determined by the controller 125 for a duration. The camera 130 captures an image of a reflection of the pattern projected by the SLM 120 during the duration wherein the pattern is projected. The controller 125 may determine a location of one or more symbols in the image captured by the camera 130 as a result of determining a location of a symbol on a determined epipolar line. Advantageously, the depth detection headlight 105 may determine a distance between the depth detection headlight 105 and a surface a symbol is projected on as a result of a single pattern projected by the SLM 120 and an image captured by the camera 130. Advantageously, the depth detection headlight 105 may generate a pattern of symbols using a limited number of symbols by generating unique sequences of symbols within the pattern.

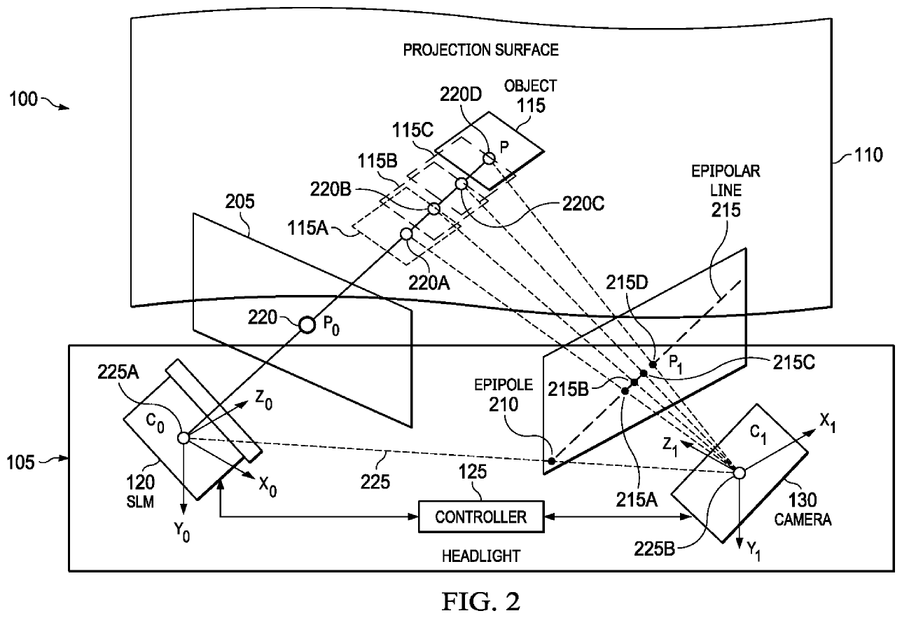

FIG. 2 is an isometric view of a block diagram of the automotive environment 100 of FIG. 1 including illustrative representatives of an example image plane 205, an example epipole 210, and an example epipolar line 215. In the example of FIG. 2, the automotive environment 100 includes the depth detection headlight 105 of FIG. 1, the projection surface 110 of FIG. 1, the object 115 of FIG. 1, the SLM 120 of FIG. 1, the controller 125 of FIG. 1, the camera 130 of FIG. 1, the image plane 205, the epipole 210, and the epipolar line 215. The depth detection headlight 105 determines a distance between the depth detection headlight 105 and the projection surface 110 or the object 115 as a result of determining a location of a symbol on the epipolar line 215. In the example of FIG. 2, the epipole 210 may be determined by the controller 125 as a result of determining the image plane 205 and an alignment of the SLM 120 in relation to the camera 130, such an alignment may be referred to as an orientation.

In the example of FIG. 2, the image plane 205 is an illustrative representation of a two-dimensional surface of which a symbol that is being projected by the SLM 120 may be located. For example, a location of a symbol comprising a pattern, being projected by the SLM 120, may be represented as a two-dimensional coordinate on the image plane 205. In some such examples, the two-dimensional coordinate of the symbol on the image plane 205 is used by the controller 125 to determine the location of a reflection of the symbol on the epipolar line 215, such that the location on the epipolar line 215 may be used to determine a depth coordinate of the symbol. The image plane 205 illustrates the field of view 120A of FIG. 1 of the SLM 120, such that any light projected by the SLM 120 may be located on the image plane 205. The image plane 205 includes an example symbol location 220. The image plane 205 allows the symbol location 220 to be illustrated as a one by two matrix including an example x-coordinate and an example y-coordinate representing a geometric location on the image plane 205. Alternatively, the symbol location 220 may include a z-axis coordinate representing a vector between the center of the SLM 120 and the image plane 205. The image plane 205 corresponds to the orientation of the SLM 120, such that a radial rotation of the SLM 120 results in a radial modification of the image plane 205. For example, a symbol being projected at the symbol location 220 may be projected onto a surface other than the object 115 without changing the two-dimensional coordinates of the symbol location 220 as a result of modifying the orientation of the SLM 120. Advantageously, a location of a symbol corresponds to a two-dimensional location on the image plane.

The image plane 205 illustrates a location of a symbol in two-dimensions, such as the symbol location 220. The controller 125 uses the two-dimensional coordinates of a symbol on the image plane 205 to determine potential locations of the symbol at the symbol location 220. A symbol projected at the symbol location 220 be found along a linear path extending from the SLM 120, through the image plane 205, to the projection surface 110 and/or the object 115, such that a three-dimensional coordinate of the symbol, at the symbol location 220, is along the linear path extending from the SLM 120. For example, a symbol projected at the symbol location 220 may be determined to have a third coordinate at a first example depth coordinate of 220A as result of the symbol being projected onto a first object 115A. In such an example, a second depth coordinate 220B corresponds to a second object 115B, such that a third depth coordinate 220C corresponds to a third object 115C and a fourth depth coordinate 220D corresponds to a depth coordinate of the object 115. Advantageously, the depth coordinate of the symbol location 220 may be determined as a result of searching along the line extending from the SLM 120 and perpendicular to the image plane 205 for the image. Advantageously, the linear path of symbol may be projected onto an image captured by the camera 130, such a projection of the linear path may be referred to as an epipolar line.

The epipole 210 is an illustrative example of an intersection of the epipolar line 215 and an example alignment vector 225. The epipole 210 is a location of a symbol closest to the SLM 120. For example, the depth of the symbol determined to be at the epipole 210 is approximately zero. The epipole 210 may be determined as a result of determining the alignment vector 225, a rotational difference, and a translational difference between the SLM 120 and the camera 130. For example, the alignment vector 225 is a vector extending from a first center point 225A of the SLM 120 to a second center point 225B of the camera 130. Alternatively, the location of the epipole 210 may be illustrated along the alignment vector 225.

The alignment vector 225 represents the alignment of the SLM 120 in relation to the camera 130, such that the SLM 120 and camera 130 may be calibrated to set the alignment vector 225 to a predetermined value. Alternatively, the alignment vector 225 may be determined as a result of determining the vector between the center points 225A and 225B. The alignment vector 225 is used by the controller 125 to determine a translation vector, which transforms the coordinates of the center point 225B of the camera 130 to the coordinates of the center point 225A of the SLM 120. In the example of FIG. 2, the alignment vector 225 is determined by a manufacturer as a result of a fixed distance between the SLM 120 and camera 130 being set during the manufacturing of the depth detection headlight 105. Advantageously, the predetermined value representative of the alignment vector 225 decreases the integration complexity of the depth detection headlight 105.

The epipolar line 215 is an illustrative example of a one-dimensional line on which a symbol may be found based on the distance of a projection surface from the center point 225A of the SLM 120. For example, a symbol being projected at the symbol location 220 may be found on the epipolar line 215 at a first depth 215A as a result of the symbol being projected on the first object 115A, such that the distance between the SLM 120 and the first object 115A is determined based on the distance between the first depth 215A and the epipole 210. In such an example, the symbol may be found at a second depth 215B as a result of the symbol being projected onto the second object 115B, such that the second object 115B is farther from the SLM 120 based on the distance between the epipole 210 and the second depth 215B being greater than the distance between the epipole 210 and the first depth 215A. Alternatively, the symbol may be found at a third point 215C as a result of the symbol being projected onto the third object 115C, such that a fourth point 215D corresponds to the object 115. Advantageously, a distance between the SLM 120 and an object is determined as a result of determining a location of a symbol on the epipolar line corresponding to the symbol location 220 on the image plane 205. Advantageously, each symbol being projected by the SLM 120 corresponds to an epipolar line as a result of each symbol having a different symbol location on the image plane 205.

The epipolar line 215 is a line that represents possible depth coordinates of a symbol at the symbol location 220, such that each symbol that is projected by the SLM 120 has an epipolar line. The epipolar line 215 may be determined based on the alignment vector 225, an example skew matrix ([t]x), and symbol location (P₀). The alignment vector 225 is a vector connecting the center point 225A of the SLM 120 to the center point 225B of the camera 130. The alignment vector 225 includes a value of a rotation vector (R) and a translation vector (t). The rotation vector represents the rotation of the SLM 120 in relation to the camera 130, such that any skew resulting from a rotation of either the SLM 120 or the camera 130 is represented in the rotation vector. The translation vector represents the offset of the center points 225A and 225B, such that any offset between the center point 225A of the SLM 120 and the center point 225B of the camera 130 is represented in the translation vector. For example, the translation vector may be used to convert the coordinates of the center point 225B of the camera 130 to the coordinates of the center point 225A of the SLM 120. The skew matrix is a skew symmetric matrix which is a three-by-three matrix representative of a cross product between the translation vector (t) and another vector, such that a dot product of the skew matrix and another vector is equal to the cross product of the translation vector and the other vector. Equation (1), below, may be used to convert the translation vector into a skew matrix, wherein t and R are three-dimensional vectors.

$$t \times R = [ \begin{matrix}0 & - {t}_{k} & {t}_{j} \\ {t}_{k} & 0 & - {t}_{i} \\ - {t}_{j} & {t}_{i} & 0\end{matrix} ] [ \begin{matrix}{R}_{i} \\ {R}_{j} \\ {R}_{k}\end{matrix} ] = [ t ] x * R , \qquad Equation ( 1 )$$

An essential matrix (E) represents a relationship between the image plane 205 and a plane of an epipolar line, which accounts for rotation and distance differences between the SLM 120 and the camera 130. The essential matrix may be determined as a result of a dot product of the skew matrix and the rotation vector. Alternatively, the essential matrix may be determined as the cross product of the translation vector and the rotation vector, as shown in Equation (1), above. The essential matrix may be determined based on Equation (2), below, wherein the essential matrix is equal to the dot product of the skew matrix and the rotation vector. Advantageously, the use of the essential matrix of Equation (2), below, decreases integration complexity of the depth detection headlight 105 as a result of using the essential matrix to determine an epipolar line for any symbol being projected by the SLM 120, such that the essential matrix only needs to be determined if there is a change in the alignment between the SLM 120 and the camera 130.

E=[t]x*\vec{R}, Equation (2)

The epipolar line 215 may be determined using a symbol location (P₀) on the image plane 205, the essential matrix, and a captured symbol location (P₁). The symbol location on the image plane 205 provides an x-axis and a y-axis coordinate of an object. The symbol location may be determined as the coordinates of the symbol being projected by the SLM 120, such that an object that a symbol is projected onto is determined to be at a location on the image plane 205 equal to the x-axis and y-axis coordinates of the symbol being projected. For example, the objects 115A-115C are all located at the symbol location 220 on the image plane 205, however, individually correspond to a different depth coordinate (the depth coordinates 220A-220D), such that P₀ is the same for all of the depth coordinates 220A-220D. The essential matrix is determined using Equation (2), above. The essential matrix defines the relationship between an orientation of the SLM 120 and the camera 130, such that the essential matrix represents both a rotation and location difference between the SLM 120 and the camera 130. The captured symbol location includes an x-axis and y-axis coordinate of a captured location of a symbol being projected at the symbol location (P₀) on the image plane. The captured symbol location may be a two-dimensional coordinate of a symbol as determined in the image captured by the camera 130 of a reflection of a pattern projected by the SLM 120. An epipolar line is all of the potential values of the captured symbol location at the symbol location on the image plane 205. The epipolar line 215 is determined as the possible P₁ values which may be obtained in which Equation (3), below, is true, such that determining possible values of the captured symbol location generates an epipolar line.

Equation (3), below, constrains determining possible values of the captured symbol location as a result of both the captured symbol location and the symbol location on the image plane corresponding to the same object, such that the vector relationship, defined by the essential matrix, may be used to determine a depth coordinate of the symbol. An epipolar line of a symbol location may be determined based on the relationship of Equation (3), below, wherein a dot product of a transpose of the symbol location, essential matrix, and captured point location equal zero. Equation (3), below, may be solved to determine a third dimension of the symbol location as a result of determining a value of a three-dimensional vector representing the symbol location. For example, the symbol location used to determine an epipolar line may include a variable third term and/or be assumed to be a normalized vector, such that the z-axis coordinate corresponds to a vector from the center point 225A having a length equal to 1. In such an example, the z-axis coordinate may be replaced with a variable and solved for once the captured symbol location is determined. Advantageously, the epipolar line 215 represents determining possible values of a captured symbol location based on a distance between the SLM 120 and the symbol.

P₀^{T}EP₁=0, Equation (3)

In example operation, the controller 125 determines a pattern of symbols by using a plurality of unique sequences of symbols to generate a grid of symbols. The pattern determined by the controller 125 includes a grid of symbols wherein each symbol corresponds to a two-dimensional point on the image plane 205. The controller 125 configures the SLM 120 to project a determined pattern onto the projection surface 110 and object 115. The controller 125 instructs the camera 130 to capture an image of a reflection of the pattern being projected by the SLM 120. The controller 125 determines the epipolar line 215 for each symbol in the pattern projected by the SLM 120 based on the alignment of the SLM 120 and camera 130. The controller 125 may determine the distance between the SLM 120 and the location that the symbol was projected onto based on the difference between the epipole 210 and the captured symbol location. Advantageously, the controller 125 may determine the location of a symbol as a result of searching the one-dimensional epipolar line 215 for the symbol and/or unique sequence corresponding to the symbol. Advantageously, the pattern generated by the controller 125 may be configured such that a plurality of symbols correspond to the epipolar line 215. Advantageously, a depth coordinate of a symbol may be determined as a result of determining a third coordinate of the symbol location.

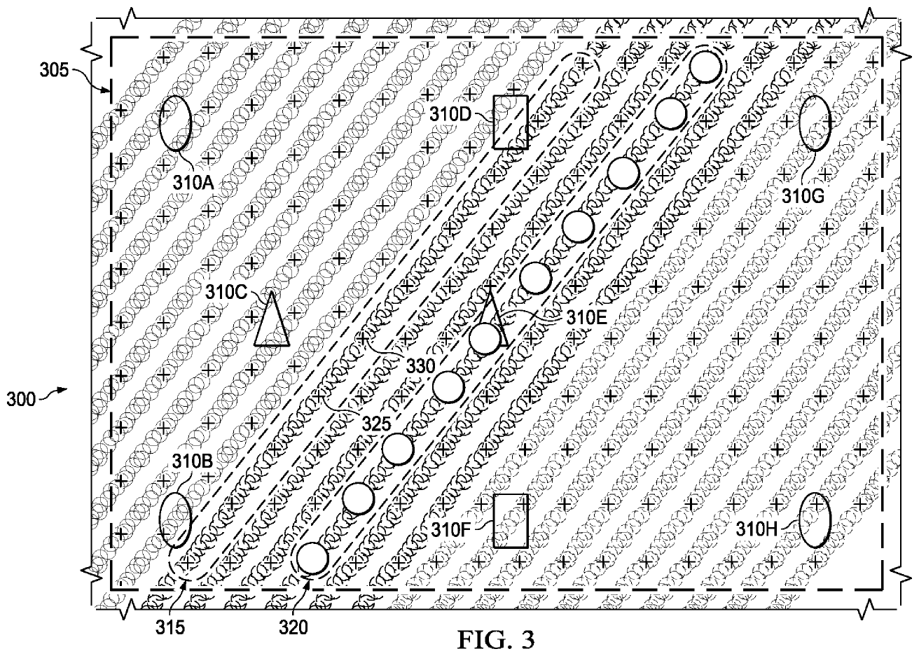

FIG. 3 is an illustrative example of a sampled grid 300 generated as a result of a search performed on an example pattern by the depth detection headlight 105 of FIG. 1. In the example of FIG. 3, the sampled grid 300 includes an example field of view 305, example symbols 310A-310H, example points 315, and an example sample of points 320. The sampled grid 300 is an illustrative example of how the controller 125 of FIG. 1 may generate a pattern based on the SLM 120 and camera 130 of FIG. 1 to determine a depth of symbols comprising a pattern. The sampled grid 300 may be determined based on a portion of the field of view of the depth detection headlight 105 that the SLM 120 may project a pattern onto, such that the camera 130 may capture the symbol in an image of a reflection of the projected pattern. The sampled grid 300 may be determined in reference to a base point (e.g., a point included in the points 315), such that a plurality of points may be determined in a coordinate system based on the base point used as reference.

In the example of FIG. 3, the field of view 305 is an illustrative example of the area that the SLM 120 may project a pattern on, such that the field of view 305 is a portion of the field of view of the depth detection headlight 105. The field of view 305 includes a plurality of epipolar lines (e.g., the epipolar line 215 of FIG. 2) corresponding to a potential location of a symbol. The potential location of a symbol corresponds to an individual epipolar line based on Equation (3), above, such that a symbol placed at any symbol location enclosed by the field of view 305 may be determined to have individual epipolar line. The epipolar lines spanning the field of view 305 are determined as a result of using a reference symbol location as the symbol location in Equation (3), above, such that every captured symbol location may be determined using the constraint of Equation (3), in which the depth of a symbol is found to be on a linear path extending from the center point 225A of the SLM 120. The epipolar lines generated using Equation (3), above, represents the possible locations in which symbols may be found, such that symbols may be found as a result of searching along the epipolar line of the symbol. The plurality of epipolar lines included in the field of view 305 are approximately parallel to each other as a result of the essential matrix determined using Equation (2), above, uniformly impacting the points comprising the field of view 305, such that the possible locations of the symbols account for rotation and distance differences between the SLM 120 and the camera 130. Advantageously, a field of view 305 may be represented as a plurality of parallel epipolar lines, in which a symbol may be placed, such that it may be found by searching along the epipolar line. Similar epipolar lines may be approximated, such that symbol locations, which share similar potential captured symbol locations, are determined to share an approximated epipolar line.

The symbols 310A-310H are an illustrative example of a pattern of geometric symbols projected by the SLM 120 to determine one or more constraints to the possible epipolar lines included in the field of view 305. For example, coordinates of the symbol 310E may be used by the controller 125 in determining possible values of the captured symbol location, such that an epipolar line is generated. In such an example, the controller 125 may offset the coordinates of the symbol 310E to determine a second epipolar line. Alternatively, the symbols 310A-310H may be used by the controller 125 to determine and/or verify the accuracy of the translation vector and/or rotation vector used in Equation (2). The symbols 310A-310H generate a grid of symbols which is less dense than the pixel density of the SLM 120, such that the constraint represented in Equation (3), above, may be used to accurately determine locations of symbols on epipolar lines. Advantageously, the approximation of epipolar lines reduces the integration complexity of the depth detection headlight 105.

The points 315 are an illustrative example of a plurality of points whose epipolar line may be modified to be equal to an approximated epipolar line based on the constraints determined by the symbols 310A-310H. For example, an epipolar line of a first point 325 may be approximated to be equal to an epipolar line of a second point 330 based on determining the epipolar lines corresponding to the points 325 and 330 are within a threshold of each other. In such an example, the threshold for approximating epipolar lines may be determined based on the symbols 310A-310H, such that the approximated epipolar line is similar to an epipolar line of a symbol included in the symbols 310A-310H. Alternatively, the approximated epipolar lines may be determined based on an approximation function. Advantageously, the points 315 may correspond to an approximated epipolar line, such that the integration complexity of the depth detection headlight 105 is reduced. Advantageously, a sequence of symbols placed on an approximated epipolar line enables the controller 125 to search along a single epipolar line to find a symbol.

The sample of points 320 is a sample of the points used to generate an approximated epipolar line. The sample of points 320 is generated as a result of the controller 125 search along an epipolar line for symbol locations which generate similar epipolar lines, such that the points comprising the sample of points 320 share an epipolar line. For example, the controller 125 may generate the sample of points 320 as a result of sampling along epipolar lines, which span the field of view 305. The sample of points 320 includes a plurality of points in which a symbol may be placed to generate a pattern of symbols which share the same epipolar line. The sample of points 320 share an epipolar line, such that depths of the symbols placed on the sample of points 320 may be determined by searching along the approximated epipolar line. The symbols assigned to the points 320 may be combined to generate a unique sequence of symbols. For example, a symbol that is placed multiple times on the points 320 may be placed based on a combination of symbols surrounding the symbol, such that an occurrence of a symbol is associated with a sequence of symbols. Advantageously, a depth of any symbol or sequence of symbols, which share an approximated epipolar line, may be determined by searching the approximated epipolar line. Advantageously, generating a pattern using a plurality of symbols that share the same epipolar line, decreases the integration complexity of the depth detection headlight 105.

In example operation, the controller 125 configures the SLM 120 to project the symbols 310A-310H onto a projection surface (e.g., the projection surface 110 of FIG. 1). The controller 125 determines a plurality of points corresponding to a plurality of epipolar lines using an image of the symbols 310A-310H captured by the camera 130. The controller 125 determines a threshold value for approximating similar epipolar lines, such that a pattern of symbols includes sequences of symbols that share an approximated epipolar line. The controller 125 may generate a plurality of epipolar lines corresponding to a cluster of points (e.g., the points 315). The controller 125 may uniformly sample the approximated epipolar lines to determine locations of symbols in a sequence. The controller 125 generates a sequence of symbols along the approximated epipolar line, such that all of the symbols in the sequence share the same epipolar line. In such an example, the sequence of symbols may include multiple occurrences of the same symbol as a result of searching the approximated epipolar line for a sequence of symbols instead the specific symbol. Advantageously, the integration complexity of the depth detection headlight is reduced as a result of placing symbols along the approximated epipolar lines, such that sequences of symbols share the same epipolar line.

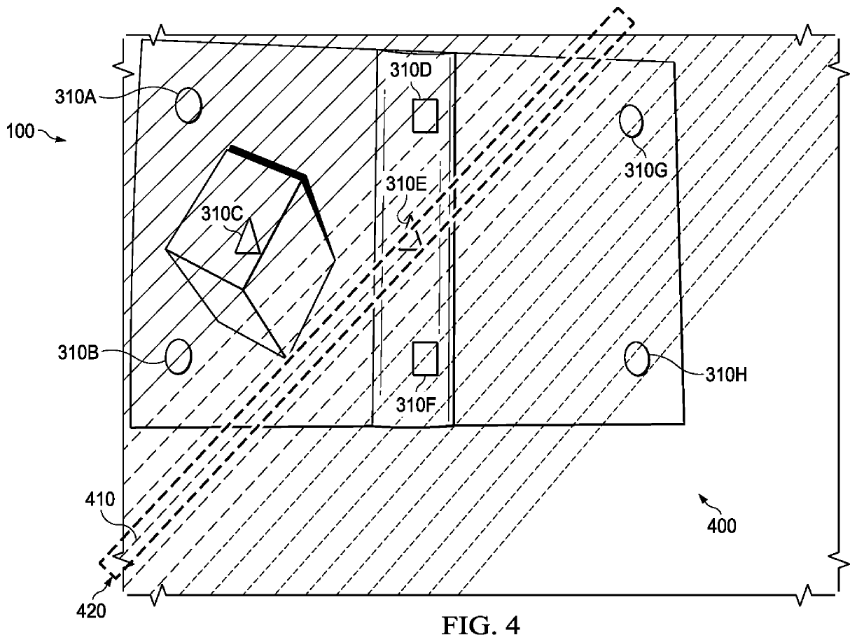

FIG. 4 is an illustrative example of epipolar lines based on the grid generated by the search illustrated in FIG. 3. In the example of FIG. 4, an example field of view 400 includes an example approximated epipolar line 410 and an approximated region 420. The field of view 400 represents an example field of view of the camera 130 of FIG. 1. The field of view 400 illustrates the approximated epipolar lines (e.g., the approximated epipolar line 410) where the controller 125 of FIG. 1 may search for symbols comprising a pattern projected by the SLM 120 of FIG. 1. Advantageously, a depth of a symbol may be determined by performing a one-dimensional search of the approximated epipolar line (e.g., the approximated epipolar line 410) corresponding to the symbol and/or sequence of symbols.

The approximated epipolar line 410 is an illustrative example of a plurality of similar epipolar lines being approximated to a singular epipolar line, such that any symbol placed along the approximated epipolar line 410 may be found by searching the approximated epipolar line 410. The approximated region 420 is an illustrative example of a portion of the field of view 400 that may be assigned a symbol corresponding to the approximated epipolar line 410. Advantageously, the controller 125 may determine the depth of any symbol within the approximated region 420 as a result of searching for the symbol on the approximated epipolar line 410.

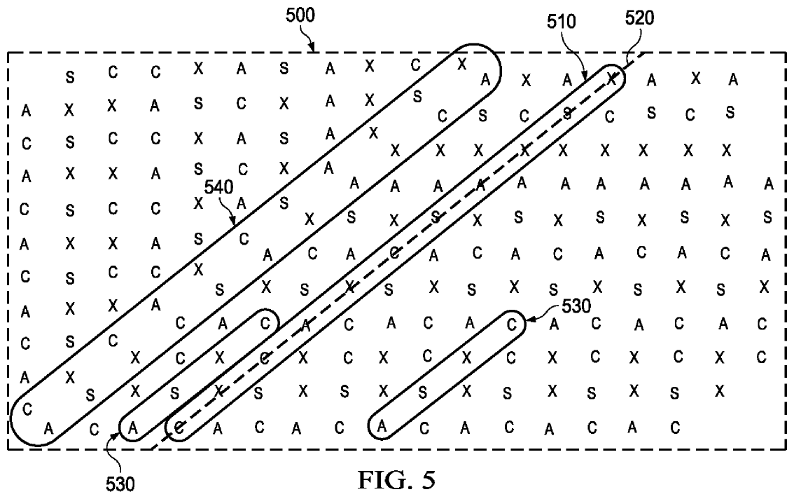

FIG. 5 is an illustrative example of an example pattern 500 of symbols to be projected by the SLM 120 of FIG. 1 and to be captured by the camera 130 of FIG. 1. In the example of FIG. 5, the pattern 500 includes an example first sequence 510, an example epipolar line 520, a second sequence 530, and a third sequence 540. The pattern 500 is a grid of symbols, generated by the controller 125 of FIG. 1 based on a plurality of approximated epipolar lines determined using Equations (1) and (2), above. The symbols of the pattern 500 are placed along the approximated epipolar lines (e.g., the approximated epipolar line 410 of FIG. 4), such that the controller 125 may determine the depth of the symbol, projected by the SLM 120, by searching along the approximated epipolar line that the symbol was generated on.

In the example of FIG. 5, the first sequence 510 is a plurality of symbols placed along the epipolar line 520. The first sequence 510 is determined based on a sequence of the symbols, such that the same symbol may be placed more than once on any epipolar line. For example, the controller 125 may determine a difference between a first occurrence of the letter “X” and a second occurrence of the letter “X” by analyzing the sequence of symbols before and/or after the occurrence of the letter “X.” In such an example, the first occurrence corresponds to a letter “C” before the first occurrence, whereas the second occurrence corresponds to a letter “A” before the second occurrence. Advantageously, the number of unique symbols may be reduced as a result of generating the pattern 500 in series of unique sequences that allow occurrences of the same symbol to be differentiated. Alternatively, the first sequence 510 may be generated using a unique symbol for each symbol location, such that each symbol only occurs once in the first sequence 510.

The epipolar line 520 is an illustrative example of an approximated epipolar line, which may be used by the controller 125 to generate the first sequence 510. The epipolar line 520 may be determined using Equations (1) and (2), above. The epipolar line 520 may be determined as a result of determining a plurality of epipolar lines based on an example symbol grid being projected (e.g., the symbols 310A-H of FIG. 3). For example, the controller 125 may configure the SLM 120 to project the pattern of symbols 310 to determine a threshold for approximating similar epipolar lines. In such an example, the controller 125 may determine one or more approximated epipolar lines to span the field of view of the SLM 120, such that the epipolar line 520 represents a portion of the field of view of the SLM 120 which may be used to determine depth. Advantageously, the controller 125 may perform a one-dimensional search of the epipolar line 520 to determine a symbol location and depth.

The second sequence 530 is a sequence of four unique symbols. The second sequence 530 may have a plurality of occurrences in the pattern 500 as a result of the controller 125 performing a one-dimensional search for any given symbol and/or sequence of symbols. For example, a first occurrence of the second sequence 530 may be generated on a first example epipolar line and a second occurrence of the second sequence 530 may be generated on a second epipolar line. In such an example, the controller 125 searches along a single epipolar line for the second sequence 530, such that the first occurrence is differentiated from the second occurrence by the epipolar line corresponding to the search being performed. Advantageously, the number of unique symbols required to generate the pattern 500 is reduced by enabling a plurality of occurrences of the same sequence of symbols (e.g., the second sequence 530) to occur across a plurality of epipolar lines.

The third sequence 540 is an illustrative example of two sequences that are not aligned in relation to each other. For example, the controller 125 may generate the third sequence 540 using a first epipolar line and a second epipolar line, wherein the first and second epipolar lines are parallel as a result of the same essential matrix being used to generate the first and second epipolar lines. In such an example, the first and second epipolar lines are offset as a result of the controller 125 determining the first and second epipolar lines using different symbol locations on the image plane 205 of FIG. 2, such that an approximation of points slightly higher on the y-axis may be determined to be a more accurate representation of the symbol locations. Advantageously, the pattern 500 may be generated by the controller 125 based on a plurality of approximated epipolar lines determined using a plurality of thresholds.

In example operation, the controller 125 projects an example pattern of symbols (e.g., the pattern of symbols 310) to determine one or more thresholds for approximating epipolar lines. A plurality of approximated epipolar lines may be determined as a result of determining the thresholds and Equations (1) and (2), above. The controller 125 determines a plurality of symbol locations on each of the approximated epipolar lines, such that the symbols may be determined based on a corresponding epipolar line. The controller 125 may determine a symbol for each determined location based on a sequence of symbols on the same epipolar line. Advantageously, the pattern 500 may be generated using a reduced number of unique symbols as a result of generating the pattern based on sequences of symbols along the same epipolar line. Advantageously, a symbol location may be determined as a result of searching along a singular epipolar line.

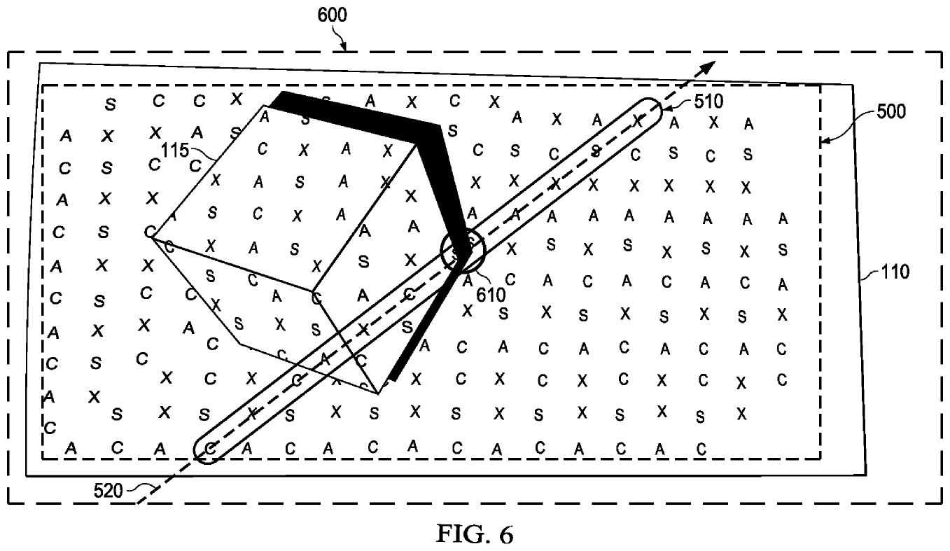

FIG. 6 is an illustrative example of an example field of view 600 of the camera 130 of FIGS. 1 and 2 used to capture a reflection of the pattern 500 of FIG. 5 projected onto the projection surface 110 of FIG. 1. In the example of FIG. 6, the field of view 600 includes the projection surface 110, the object 115 of FIG. 1, the pattern 500, the first sequence 510 of FIG. 1, and the epipolar line 520 of FIG. 5. The field of view 600 is an illustrative example of an image that may be captured by the camera 130 during a duration that the SLM 120 of FIG. 1 projects the pattern 500 onto the projection surface 110 and the object 115.

In the example of FIG. 6, the pattern 500 is projected onto the projection surface 110 and the object 115 by the SLM 120. The first sequence 510, corresponding to the epipolar line 520 is projected onto both the projection surface 110 and the object 115. The symbols comprising the first sequence 510 may be found by the controller 125 as a result of searching along the epipolar line 520. The projection of the first sequence 510 onto both the projection surface 110 and the object 115 may cause the locations of individual symbols to move along the epipolar line 520 based on a feature of the object 115. Alternatively, the pattern 500 may be projected onto a complex environment to determine a depth of a plurality of points across a plurality of objects (e.g., the object 115). Advantageously, the symbols comprising the first sequence 510 remain along the epipolar line 520 despite the projection onto both the projection surface 110 and object 115.

An example symbol 610 projected on both the projection surface 110 and the object 115 may be determined based on a sequence of symbols before and/or after the symbol 610. For example, the controller 125 may determine the symbol 610 is projected onto one or more surfaces as a result of determining the symbol location in a sequence and searching for the sequence. In such an example, the symbol 610 may be located based on one or more symbols before and/or after the symbol. A sliding window search may be performed by the controller 125 to determine the exact symbol which may be obstructed by a projection onto one or more surfaces. Alternatively, any method of search may be performed along one or more epipolar lines to determine a missing or distorted symbol. Advantageously, symbols that are distorted by unique environments may be determined as a result of a unique sequence of symbols corresponding to a distorted symbol. Advantageously, objects preventing the pattern 500 from being projected onto the projection surface 110 do not alter the location of symbols along any epipolar line.

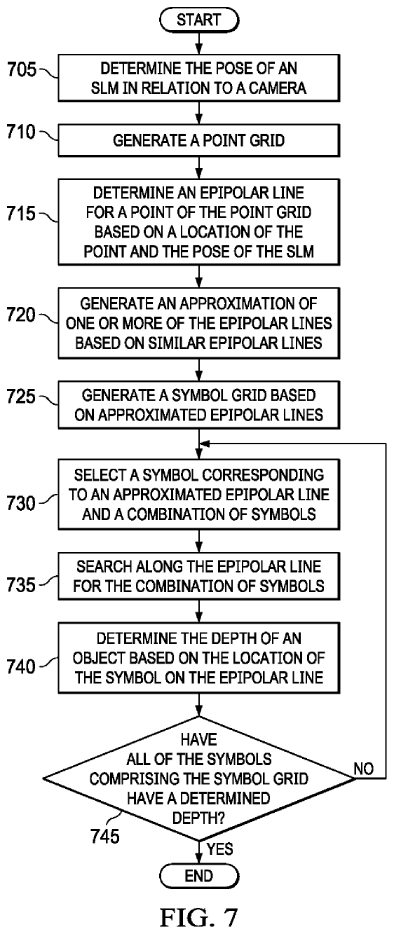

FIG. 7 is a flowchart representative of an example process that may be performed using machine readable instructions that can be executed and/or hardware configured to implement the depth detection headlight 105 of FIG. 1, and/or, more generally, the SLM 120 and camera 130 of FIG. 1 to determine the depth of the symbols included in the pattern 500 of FIGS. 5 and 6. In the example of FIG. 7, the controller 125 of FIG. 1 begins at block 705, where the controller 125 determines the pose of an SLM in relation to a camera. For example, the controller 125 may determine the essential matrix of Equation (2), above, as a result of determining a translation vector and a rotation matrix. The essential matrix represents the difference in the pose between the SLM 120 of FIGS. 1 and 2 and the camera 130 of FIGS. 1 and 2. In such an example, the translation vector is a matrix that translates the coordinates of the center point 225B of the camera 130 to be approximately (preferably exactly) equal to the coordinates of the center point 225A of the SLM 120 and the rotation vector is a matrix that translates the rotation of the camera 130 to be approximately (preferably exactly) equal to the rotation of the SLM 120. The pose of the SLM 120 in relation to the camera 130 is illustrated as the essential matrix of Equation (2), above, where the essential matrix is equal to the cross product of the translation vector (t) and the rotation vector. Alternatively, the rotation vector and the translation vector may be values determined by the manufacturer, such that center points 225A and 225B of the SLM 120 and the camera 130 are at a fixed distance and rotation. Advantageously, the essential matrix may be applied to all symbol locations (P₀), such that the essential matrix applies to all symbols being projected. The controller 125 proceeds to block 710.

At block 710, the controller 125 generates a point grid. For example, the controller 125 may uniformly sample the field of view 305 of FIG. 3 to generate a point grid of symbol locations, where if symbols were to be placed and/or found correspond to a point location on the generated grid. In such an example, the controller 125 may verify the accuracy of the essential matrix, determined at block 705, as a result of comparing captured symbol locations of the symbols 310A-310H of FIG. 3 to the symbol locations of the symbols 310A-310H in the generated grid. The coordinates of points in the generated point grid may be converted to coordinates of the camera 130 as a result of using Equation (3), above. Advantageously, the integration complexity of the depth detection headlight may be reduced as a result of decreasing the number of points generated by sampling the field of view 305. The controller 125 proceeds to block 715.

At block 715, the controller 125 determines an epipolar line for a point of the point grid based on a location of the point on the point grid and the pose of the SLM. For example, Equation (3), above, may be used to determine an epipolar line of any point based on the essential matrix determined at block 705 using Equation (2), above. In such an example, the symbol location (P₀) on the grid determined at block 710 and essential matrix may be used to determine the possible values of the captured symbol location (P₁), which may be represented in reference to an epipole. Advantageously, using Equations (1) and (2) an epipolar line may be determined for the points comprising the point grid. Advantageously, the depth of a symbol may be determined based on the captured symbol location. The controller 125 proceeds to block 720.

At block 720, the controller 125 generate an approximation of one or more of the epipolar lines based on similar epipolar lines. For example, the controller 125 may generate an approximated epipolar line for all of the points comprising the cluster of points 315, such that an approximated epipolar line (e.g., the approximated epipolar line 410 of FIG. 4) may represent all of the points within a portion projection (e.g., the approximated region 420 of FIG. 4). In such an example, the approximated epipolar line may represent a plurality of similar epipolar lines within a threshold distance. The controller 125 may approximate epipolar lines based on symbol locations which may be determined to have similar captured symbol locations. Advantageously, the controller 125 reduces the integration complexity of the depth detection headlight 105 of FIG. 1 as a result of reducing the number of potential epipolar lines that may be searched for symbols. The controller 125 proceeds to block 725.

At block 725, the controller 125 generates a symbol grid based on approximated epipolar lines. For example, the controller 125 may generate the pattern 500 of FIG. 5 as a result of determining symbol locations by sampling points along the approximated epipolar lines determined at block 720. In such an example, the controller 125 may assign a symbol to each sampled location based on a combination of symbols to generate a sequence of symbols (e.g., the sequences 510, 530, and 540 of FIG. 5) corresponding to a portion the epipolar lines. Advantageously, the number of unique symbols used to generate a grid of symbols is reduced as a result of assigning symbols to locations based on a sequence of symbols generated by placing the symbol and the approximated epipolar line corresponding to the symbol. Advantageously, the location the symbols in a captured image may be determined as a result of performing a search of the approximated epipolar line corresponding to the symbol. Advantageously, the controller 125 generates a pattern (e.g., the pattern 500) that may be projected by the SLM 120 to determine the depth the symbols comprising the pattern. The controller proceeds to block 730.

At block 730, the controller 125 selects a symbol corresponding to an approximated epipolar line and a combination of symbols. For example, the controller 125 may attempt to determine the depth of a second occurrence of the letter “X” on the epipolar line 520 of FIG. 5 by searching the epipolar line for the sequence of symbols (e.g., the sequences 510 and 530) associated with the second occurrence. In such an example, the controller 125 may select any symbol corresponding to any of the epipolar lines determined at block 720 and a sequence of symbols corresponding to the occurrence of the symbol on the epipolar line. Advantageously, any unique occurrence of a symbol may be found by the controller 125 by searching the symbols epipolar line for a sequence of symbols associated with the symbol. The controller 125 proceeds to block 735.

At block 735, the controller 125 searches along the epipolar line for the combination of symbols. For example, the controller 125 may search an image captured by the camera 130 (e.g., the field of view 600 of FIG. 6) for the epipolar line corresponding to a selected symbol. In such an example, the controller 125 may search the epipolar line for a sequence of symbols (e.g., the sequences 510 and 530) that come before and/or after the selected symbol. Advantageously, the selected symbol may be found as a result of searching an epipolar line for the sequence corresponding to the selected symbol. The controller 125 proceeds to block 740.

At block 740, the controller 125 determines the depth of an object based on the location of the symbol on the epipolar line. For example, the controller 125 may determine the depth of a symbol based on the distance between the perceived location of the point on the epipolar line and the epipole 210 of FIG. 2. In such examples, the epipole 210 is the minimum depth that may be determined by the depth detection headlight 105. The controller 125 may determine a depth coordinate of a symbol at a symbol location as a result of solving Equation (3), above, for a depth coordinate. Advantageously, the depth of a symbol may be determined based on a location of the symbol on the epipolar line in relation to the epipole 210. The controller 125 proceeds to block 745.

At block 745, the controller 125 determines if all of the symbols of the symbol grid have a determined depth. For example, the depth detection headlight 105 may determine the depth of all of the symbols comprising the pattern 500 to determine whether an object (e.g., the object 115 of FIGS. 1 and 2) are present. In some such examples, the depth detection headlight 105 may determine the presence of an object as a result of a change in depth across a plurality of symbols. Advantageously, the depth detection headlight 105 may search portions of the pattern 500 for objects by searching for symbols corresponding to the portions of the pattern 500 to be searched. The controller 125 proceeds to block 730 as a result of determining that not all symbols have a determined depth. The controller 125 proceeds to end as a result of determining that all of the symbols have a determined depth. Alternatively, the controller 125 may determine the depth of a portion of the pattern 500.

Although example methods are described with reference to the flowchart illustrated in FIG. 7, many other methods of depth detection using epipolar geometry may alternatively be used in accordance with the in accordance with this description. For example, the order of execution of the blocks may be changed, and/or some of the blocks described may be changed, eliminated, or combined. Similarly, additional operations may be included in the manufacturing process before, in between, or after the blocks shown in the illustrated examples.

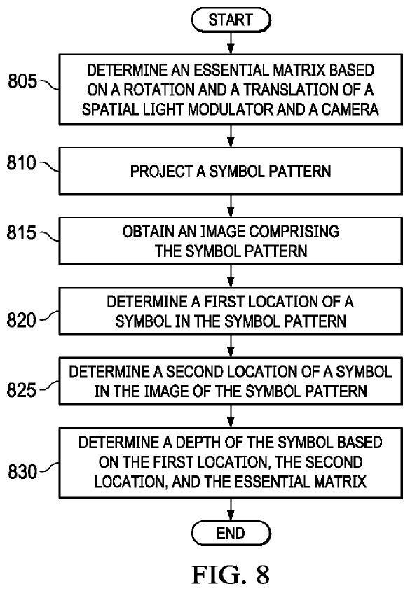

FIG. 8 is a flowchart representative of an example process that may be performed using machine readable instructions that can be executed and/or hardware configured to implement the depth detection headlight 105 of FIG. 1, and/or, more generally, the SLM 120, controller 125, the illumination source 128, and the camera 130 of FIGS. 1 and 2 to determine the depth of the symbols included in the pattern 500 of FIGS. 5 and 6 using an essential matrix. The process begins at block 805.

At block 805, the controller 125 determines an essential matrix based on a rotation and a translation of a spatial light modulator and a camera. For example, the depth detection headlight 105 of FIG. 1 may be manufactured to include predetermined rotation and translation difference between the SLM 120 and the camera 130, such that a rotation and translation vector may be set by a manufacturer to decrease system complexity. In such an example, the essential matrix may be determined using Equation (2), above, as a result of a cross product of the translation vector and the rotation vector. The essential matrix is a matrix that represents the difference in rotation and location of the center points 225A and 225B of the SLM 120 and the camera 130. The essential matrix may be used by the depth detection headlight to compare the symbol location on the image plane 205 to the captured symbol location in the image captured by the camera 130. The controller 125 proceeds to block 810.

At block 810, the SLM 120, the illumination source 128, and the controller 125 project a symbol pattern. The controller 125 generates instructions to instruct the SLM 120 and the illumination source 128 project a symbol pattern. For example, the controller 125 instructs the SLM 120 and the illumination source 128 to project the pattern 500. In such an example, the pattern 500 may be generated using the blocks 710-725 of FIG. 7, such that the symbols comprising the pattern 500 are placed based on epipolar lines, determined using Equations (2) and (3), above. The pattern 500 contains symbols at symbol locations (e.g., the symbol location 220 of FIG. 2) on the image plane 205 of FIG. 2 of the SLM 120. The symbol locations of the pattern 500 may be determined as the symbol locations used by Equation (3), above, to determine epipolar lines of the symbols in an image of the pattern. The controller 125 proceeds to block 815.

At block 815, the controller 125 obtains an image comprising the symbol pattern. For example, the controller 125 instructs the camera 130 to capture an image of a reflection of the pattern 500 projected by the SLM 120. The image captured by the camera 130 may include the field of view 305 of FIG. 3, such that the controller 125 may use the epipolar lines which were used to generate the pattern 500 to determine whether or not there was a change in pose between the SLM 120 and the camera 130. Advantageously, the captured image includes captured symbol locations of the pattern 500. The controller 125 proceeds to block 820.

At block 820, the controller 125 determines a first location of a symbol in the symbol pattern. For example, the controller 125 determines a first location to correspond to the first occurrence of the symbol “X” on the epipolar line 520 as a result of determining the coordinates of the point in the sample of points 320 of FIG. 3, which was used to place the symbol in the pattern 500. Advantageously, the controller 125 may use the coordinates of points of the sample of points 320 as the symbol locations of the symbols comprising the pattern 500 on the epipolar line 520. The controller 125 proceeds to block 825.

At block 825, the controller 125 determines a second location of the symbol in the image of the symbol pattern. For example, the controller 125 determines an epipolar line of the symbol based on the symbol location in the pattern 500 to search along in the image obtained at block 815. In such an example, the controller 125 may determine the coordinates of the epipolar line in the image using Equation (3), above, where the symbol location is the first location determined at block 820, and the possible captured symbol locations correspond to the epipolar line to be search for the symbol. The controller 125 may be configured to search along an epipolar line corresponding to the symbol location of the pattern 500, such that the controller 125 may perform a one-dimensional search along the epipolar line of the symbol. The controller 125 may use a sliding window search to search along the epipolar line, such that every possible sequence of symbols (e.g., the second sequence 530 of FIG. 5) may be searched for a specific occurrence. The controller 125 may differentiate occurrences of the same symbol as a result of determining a symbol prior to and/or following the symbol being searched for. Such symbols share an epipolar line with the symbol may be searched for by the controller 125. For example, the controller 125 searches for a second occurrence of the letter “X” on the epipolar line 520 by searching for a sequence of symbols “AXC,” which differentiates the second occurrence from one or more occurrences of the letter “X” on the epipolar line 520. Advantageously, the symbol pattern 500 may be constructed using a reduced number of symbols as a result of differentiating occurrences of a symbol on the same epipolar line using a sequence of symbols. The controller proceeds to block 830.

At block 830, the controller 125 determines a depth of the symbol based on the first location, the second location, and the essential matrix. For example, the controller 125 determines a depth coordinate (such as a z-axis coordinate) as a result of solving Equation (3), above, for the three-dimensional coordinate shared by both P₀ and P₁. In such an example, the essential matrix is determined at block 805, the symbol location (P₀) includes the first location determined at block 820, and the captured symbol location (P₁) includes the second location determined at block 825. The controller 125 may repeat the process of blocks 820-830 one or more times, where each time the process is repeated the controller 125 uses a different symbol, to determine a plurality of depths in the image obtained at block 815. The controller 125 may proceed to block 810 as a result of determining a change in a surface that the symbol pattern was projected onto at block 810. The controller 125 proceeds to end the process of FIG. 8.

Advantageously, the depth detection headlight 105 may determine the depth of a location in which a symbol is projected as a result of obtaining a single image. Advantageously, integration complexity of depth detection using epipolar lines is reduced as a result of determining the first location of the symbol as a result of using the SLM 120 to project the image at a determined first location, such that only one image needs to be searched for the symbol. Advantageously, the integration complexity of using Equation (3), above, to determine a depth of a symbol location is reduced as a result of using the essential matrix, determined at block 805, for one or more symbols and/or one or more obtained images.

Although example methods are described with reference to the flowchart illustrated in FIG. 8, many other methods of depth detection using epipolar geometry may alternatively be used in accordance with the in accordance with this description. For example, the order of execution of the blocks may be changed, and/or some of the blocks described may be changed, eliminated, or combined. Similarly, additional operations may be included in the manufacturing process before, in between, or after the blocks shown in the illustrated examples.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means+/−10 percent of the stated value.

Modifications are possible in the described embodiments, and other embodiments are possible, within the scope of the claims.

What is claimed is:

1. A controller configured to:
generate a symbol pattern as a result of placing symbols based on epipolar lines;
instruct an SLM to project the symbol pattern;
obtain an image of a reflection of the symbol pattern;
determine a first location of a symbol in the image;
determine a second location of the symbol in the image; and
determine a depth of the symbol as based on the first location, the second location, and an essential matrix.

2. The controller of claim 1, further configured to determine the essential matrix based on a difference in rotation and translation between a camera and the SLM, the camera used to obtain the image of the reflection of the symbol pattern.

3. The controller of claim 1, further configured to determine the epipolar lines, used to generate the symbol pattern, as a result of determining possible values of the second location based on the essential matrix and the first location.

4. The controller of claim 1, further configured to generate the symbol pattern using a plurality of sequences of symbols that share an epipolar line, the sequences of symbols including a plurality of symbols that differentiate a first occurrence of the symbol on the epipolar line from a second occurrence of the symbol on the epipolar line.

5. The controller of claim 1, further configured to search along an epipolar line, used to generate the symbol pattern, corresponding to the symbol for a sequence of symbols to differentiate a first occurrence of the symbol from a second occurrence of the symbol.

6. The controller of claim 1, further configured to determine the depth of the symbol as a result of solving for a depth coordinate in an equation wherein a dot product of a transpose of the first location, the essential matrix, and the second location is equal to zero.

7. A system comprising:
a spatial light modulator (SLM) configured to project a symbol pattern;
a camera configured to obtain an image of a reflection of the symbol pattern;
a controller coupled to the SLM and the camera, the controller configured to:
determine a first location of a symbol in the image;
determine a second location of the symbol in the image; and
determine a depth of the symbol as based on the first location, the second location, and an essential matrix.

8. The system of claim 7, the controller further configured to determine the essential matrix based on a difference in rotation and translation between the camera and the SLM.

9. The system of claim 7, the controller further configured to determine epipolar lines as a result of determining possible values of the second location based on the essential matrix and the first location.

10. The system of claim 9, the controller further configured to generate the symbol pattern as a result of placing symbols at symbol locations along the epipolar lines.

11. The system of claim 7, the controller further configured to generate the symbol pattern using a plurality of sequences of symbols that share an epipolar line, the sequences of symbols including a plurality of symbols that differentiate a first occurrence of the symbol on the epipolar line from a second occurrence of the symbol on the epipolar line.

12. The system of claim 7, the controller further configured to search along an epipolar line of the symbol for a sequence of symbols to differentiate a first occurrence of the symbol from a second occurrence of the symbol.

13. The system of claim 7, the controller further configured to determine the depth of the symbol as a result of solving for a depth coordinate in an equation wherein a dot product of a transpose of the first location, the essential matrix, and the second location is equal to zero.

14. A vehicle comprising:
a headlight comprising:
a spatial light modulator (SLM) configured to project a symbol pattern;
a camera configured to obtain an image of a reflection of the symbol pattern; and
a controller coupled to the SLM and the camera, the controller configured to:
determine a first location of a symbol in the symbol pattern;
determine a second location of the symbol in the image; and
determine a depth of the symbol as based on the first location, the second location, and an essential matrix.

15. The vehicle of claim 14, the controller further configured to determine the essential matrix based on a difference in rotation and translation between the camera and the SLM.

16. The vehicle of claim 14, further configured to determine epipolar lines as a result of determining possible values of the second location based on the essential matrix and the first location.

17. The vehicle of claim 16, further configured to generate the symbol pattern as a result of placing symbols at symbol locations along the epipolar lines.

18. The vehicle of claim 14, further configured to generate the symbol pattern using a plurality of sequences of symbols that share an epipolar line, the sequences of symbols including a plurality of symbols that differentiate a first occurrence of the symbol on the epipolar line from a second occurrence of the symbol on the epipolar line.

19. The vehicle of claim 14, further configured to search along an epipolar line of the symbol for a sequence of symbols to differentiate a first occurrence of the symbol from a second occurrence of the symbol.

20. The vehicle of claim 14, further configured to determine the depth of the symbol as a result of solving for a depth coordinate in an equation wherein a dot product of a transpose of the first location, the essential matrix, and the second location is equal to zero.
